(19) United States
(12) Patent Application Publication
(10) Pub. No.: US 2016/0013991 A1
(43) Pub. Date: Jan. 14, 2016

(54) ANALYTICS-DRIVEN POLICY CONTROL IN COMPUTER NETWORKS

(71) Applicant: Benjamin Parker, San Mateo, CA (US)

(72) Inventor: Benjamin Parker, San Mateo, CA (US)

(21) Appl. No.: 14/795,000

(22) Filed: Jul. 9, 2015

Related U.S. Application Data
(60) Provisional application No. 62/022,948, filed on Jul. 10, 2014.

(51) Int. Cl. H04L 12/24; H04M 15/00; G06Q 30/02

(52) U.S. Cl. CPC H04L 41/5016; G06Q 30/0204; H04M 15/58; H04M 15/886

(57) ABSTRACT

Methods and systems for allocating computer-network resources among a group of network users calculate, for each network user, a worth of that network user based at least on a usage fee paid by that network user and a cost of that network user based at least on a network bandwidth consumed by that network user. For each network user, a worth-to-cost ratio based on the worth and cost of that network user may be computed. A group of high-value network users and a group of low-value network users may be identified such that each high-value network user has a higher worth-to-cost ratio than that of each low-value network user. Preferential access to a network resource is provided to the group of high-value network users relative to an access provided to the group of low-value network users.

### PRIORITY CLAIM AND RELATED APPLICATION

This application claims priority to U.S. Provisional Application No. 62/022,948, entitled “Analytics for Policy Control in a Mobile or Fixed Network,” filed Jul. 10, 2014, the entire disclosure of which is hereby incorporated by reference.

### FIELD OF THE APPLICATION

The present application generally relates to the field of computer networks, and more particularly to an analytics-driven policy control method and system for computer networks.

### BACKGROUND

Computer networks, including cellular/mobile networks, wireless networks, and wired networks (or portions thereof) are limited to a maximum capacity (e.g., bandwidth or throughput) based on the design or implementation of the networks. Very frequently, this capacity must be allocated among multiple users or clients, each of which may place greater or lesser demands for capacity on the network. A network “policy” refers to a set of rules for allocating this network capacity amongst the users or clients. In existing networks, there may be many policy-enforcement points, each of which is controlled by policy controllers implementing policy charging and rules functions (“PCRFs”). In many cases, the policy controllers adjust policies based on any of a number of input variables, such as time of day, day of week, bandwidth caps, or any other real-time or non-real-time variables.

Existing network policies may be very coarse and may be used to manage very generic network resources. For example, data rates may be reduced for subscribers who utilize more than an allocated amount of data for a period of time. Other examples include implementing rate clamping at a packet gateway (“PGW”) during specific times of day. These policy changes, however, typically respond to events after they happen and do not allow for fined-grained control of network resources.

Therefore, a need exists for a system and method for an analytics-driven solution that implements polices that map to network management objectives on a moment by moment basis.

### SUMMARY

Embodiments disclosed herein relate to systems and methods for allocating network resources in a computer network. Systems may include nonvolatile computer storage including a database for storing user information of a group of network users. In various embodiments, the database includes records that specify, for each network user from the group of network users, (i) a set of worth factors and worth weights associated with each of the worth factors, and (ii) a set of cost factors and cost weights associated with each of the cost factors. The system includes one or more computer processors configured for executing computer instructions. The system also includes a network controller for allocating network resources among the group of network users.

Systems in accordance herewith may further include a user analysis module executable by the computer processor(s). The user analysis module may be configured to compute, for each network user from the group of network users, a cost based at least on the cost factors and cost weights associated with that network user. In some instances, the cost factors for a network user include a network bandwidth consumed by that network user.

The user analysis module may be configured to compute, for each network user from the group of network users, a worth based at least on the worth factors and worth weights associated with that network user. In some instances, the worth factors for a network user include usage fees paid by that network user. The user analysis module may be configured to compute, for each network user from the group of network users, a worth-to-cost ratio based on the worth and cost of that network user. The user analysis module may identify a group of high-value network users and a group of low-value network users from the group of network users, where each network user from the group of high-value network users has a worth-to-cost ratio higher than a worth-to-cost ratio of each network user from the group of low-value network users.

The user analysis module is further configured to cause the network controller to provide a preferential access to at least one network resource to the group of high-value network users relative to an access provided to the group of low-value network users. Accordingly, in some instances, the network controller is configured to provide the preferential access to the at least one network resource by transmitting a policy-update command associated with the at least one network resource to a network node or element in the computer network. Furthermore, in some instances, the at least one network resource includes a network bandwidth associated with the computer network. Additionally, in some instances, the preferential access includes an access to a 4G network in lieu of a 3G network or an access to a 3G network in lieu of a 2G network.

In another aspect, the invention pertains to a method for allocating network resources in a computer network. Embodiments of the method can include calculating, for each network user from a set of network users, a worth of that network user based at least on a usage fee paid by that network user. In some instances, the worth of a network user may be calculated based on at least one of a payment history, payment promptness, overage charge history, or overage charge payment promptness of that network user. Embodiments of the method include calculating, for each network user from the set of network users, a cost of that network user based at least on a network bandwidth consumed by that network user. In some instances, the cost of a network user may be calculated based on at least one of a complaint-filing history, peak-time usage history, or file-sharing history of that network user.

The method may then include calculating, for each network user from the set of network users, a worth-to-cost ratio based on the worth and cost of that network user. A group of high-value network users and a group of low-value network users may then be identified from the set of network users. Each network user from the group of high-value network users has a worth-to-cost ratio higher than a worth-to-cost ratio of each network user from the group of low-value network users.

In various embodiments, the method further includes providing a preferential access to at least one network resource to the group of high-value network users relative to an access provided to the group of low-value network users. In some embodiments, the preferential access may be provided by, for example, transmitting a policy-update command to a network node or element associated with the network resource. In some instances, the preferential access is associated with at least one of a network bandwidth, network throughput, or network-connection order associated with the network resource. The preferential access may include, for example, an access to a 4G network in lieu of a 3G network or an access to a 3G network in lieu of a 2G network.

In some embodiments, additionally, the method includes detecting, in real time and prior to providing the preferential access, an over-allocation condition of the network resource. In such embodiments, the method may further include providing a preferential access to the network resource to the group of low-value network users when the over-allocation condition ceases.

In still another aspect, the invention relates to a server device for allocating network resources in a computer network among a set of network users. In some instances, the network resource(s) include a network bandwidth associated with the computer network. The server device may include a user analysis module and a network controller module. The user analysis module is configured to retrieve, from a database storing user-specific data for the set of network users, payment data and usage data of each network user from the set of network users. The user analysis module is then configured to compute, for each network user from the set of network users, a worth based on the payment data of that network user, and a worth based on the usage data of that network user. In some instances, the payment data of a network user includes usage fees paid by that network user; and the usage data of a network user includes a network bandwidth consumed by that network user.

The user analysis module is thus configured to compute, for each network user from the set of network users, a worth-to-cost ratio based on the worth and cost of that network user. The user analysis module is also configured to identify a group of high-value network users and a group of low-value network users from the set of network users, wherein each network user from the group of high-value network users has a worth-to-cost ratio higher than a worth-to-cost ratio of each network user from the group of low-value network users.

The user analysis module may be further configured to send, to the network controller module, a signal containing information regarding the high-value network users. In response to receiving the signal from the user analysis module, the network controller module is configured to provide a preferential access to at least one network resource to the group of high-value network users relative to the access provided to the group of low-value network users.

Additionally, in some embodiments, the user analysis module is configured to detect, in real time and prior to sending the signal, an over-allocation condition of the network resource(s) based on the usage data of the set of network users. In such embodiments, the network controller module can be configured to provide preferential access to the network resource(s) to the group of low-value network users when the over-allocation condition ceases.

Various advantages of the present application are apparent in light of the descriptions below.

### BRIEF DESCRIPTION OF THE DRAWINGS

The aforementioned implementation of the present application as well as additional implementations will be more clearly understood as a result of the following detailed description of the various aspects of the application when taken in conjunction with the drawings.

FIG. 1 is a schematic illustration of a system for allocating network resources in a computer network in accordance with some embodiments.

FIG. 2 is a schematic illustration of another system for allocating network resources in a computer network in accordance with some embodiments.

### DETAILED DESCRIPTION

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

To promote an understanding of the objectives, technical solutions, and advantages of the present application, embodiments of the present application are further described in detail below with reference to the accompanying drawings.

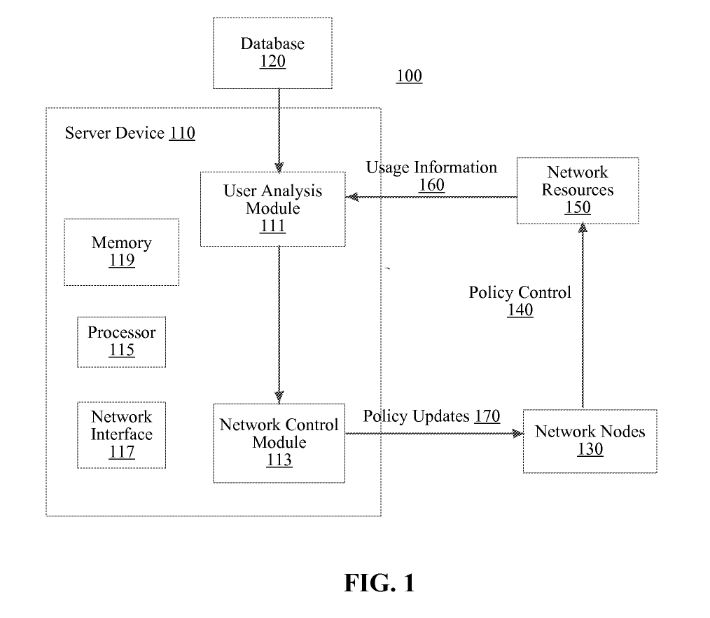

FIG. 1 is a schematic illustration of a system 100 for allocating network resources in a computer network in accordance with some embodiments. As shown in FIG. 1, the system 100 includes a server device 110, a database 120 that is accessible to the server device 110, one or more network nodes 130 deployed in the computer network, and one or more network resources 150. In some embodiments, components of the system 100 can be interconnected with each other via the computer network. For example, the server device 110 may connected to the network node(s) via the computer network. Thus, the database 120 may be located on a remote device, in which case the server device 100 can access and retrieve data from the database 120 via the computer network; or the database 120 may be local to the server and stored on nonvolatile storage thereof; or it may be distributed so that portions are local and portions are remote.

Although not shown in FIG. 1, the computer network (for which the system 100 is configured to allocate network resources) can include various interconnected devices to support wired, wireless, or any other type of two-way communications. In some embodiments, the computer network can be any type of network configured to operatively couple one or more devices (e.g., servers devices, user devices, networking devices, etc.), and enable communications between those devices. In some embodiments, the computer network can include one or more networks such as, for example, a cellular network, a satellite network, a local area network (LAN), a wide area network (WAN), a wireless local area network (WLAN), or any wide-area network or combination of networks capable of supporting point-to-point data transfer and communication. In some embodiments, the computer network can include the Internet.

In some embodiments, the computer network can be optionally implemented using any known network protocol including various wired and/or wireless protocols such as, for example, Ethernet, universal serial bus (USB), global system for mobile communications (GSM), enhanced data GSM environment (EDGE), general packet radio service (GPRS), long term evolution (LTE), code division multiple access (CDMA), wideband code division multiple Access (WCDMA), time division multiple access (TDMA), bluetooth, Wi-Fi, voice over internet protocol (VoIP), Wi-MAX, etc.

As shown in FIG. 1, the server device 110 includes a processor 115, a network interface 117, a memory 119, a user analysis module 111 and a network control module 113. In some embodiments, the server device 110 can be, for example, a background server, a back end server, a database server, a workstation, a desktop computer, a cloud computing server, a data processing server, and/or the like. In some embodiments, such a server device can be a server cluster or server center consisting of two or more servers (e.g., a data processing server and a database server).

The memory 119 is configured to store software programs and/or instructions for the modules of the server device 110 (e.g., the user analysis module 111, the network control module 113). In some embodiments, the memory 119 can include, for example, one or more random-access memory (RAM) (e.g., a DRAM, a SRAM, a DDR RAM, etc.), read only memory (ROM), non-volatile memory such as one or more magnetic disk storage devices, optical disk storage devices, flash memory devices, or other non-volatile solid state storage devices. In some embodiments, the memory 119 can include one or more storage devices (e.g., a removable memory) remotely located from other components of the server device 110.

In some embodiments, a basic input/output system (BIOS), containing the basic routines that help to transfer information between elements, such as during start-up, is typically stored in ROM. RAM typically contains data and/or program modules (e.g., the user analysis module 111, the network control module 113) that are immediately accessible to and/or presently being operated on by processing unit. The data or program modules may include an operating system, application programs, other program modules, and program data. The operating system may be or include a variety of operating systems such as Microsoft WINDOWS operating system, the UNIX operating system, the LINUX operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, an OPENSTEP operating system or another operating system of platform.

In some embodiments, the memory 119 may also include other removable or nonremovable, volatile or nonvolatile computer storage media. For example, a hard disk drive may read or write to nonremovable, nonvolatile magnetic media. A magnetic disk drive may read from or write to a removable, nonvolatile magnetic disk, and an optical disk drive may read from or write to a removable, nonvolatile optical disk such as a CD-ROM or other optical media. Other removable or nonremovable, volatile or nonvolatile computer storage media that can be used in the exemplary operating environment include, but are not limited to, magnetic tape cassettes, flash memory cards, digital versatile disks, digital video tape, solid state RAM, solid state ROM, and the like. The memory 119 can be connected to a system bus (not shown in FIG. 1) through a removable or non-removable memory interface.

The processor 115 can execute various applications, programs and/or functions included in the software programs and/or modules stored in the memory 119. In some embodiments, the processor 115 can be any processing device capable of performing at least a portion of the method for allocating network resources 150 among users (or customers) of the computer network, as described below. Such a processor can be, for example, a central processing unit (CPU), a digital signal processor (DSP), a field programmable gate array (FPGA), an application-specific integrated circuit (ASIC), and/or the like. The processor 115 can be configured to control the operations of other components and/or modules of the server device 110. For example, the processor 115 can be configured to control operations of the network interface 117. For another example, the processor 115 can be configured to execute instructions or code stored in a software program or module (e.g., the user analysis module 111, the network control module 113) within the memory 119.

The network interface 117 is configured to provide and control network interfaces of the server device 110 that are used to interact with other network devices (e.g., network nodes 130, database 120). The network interface 117 can include, for example, a standard wired interface and/or a standard wireless interface (e.g., a Wi-Fi interface). In some embodiments, the network interface 117 is used for connecting one or more network devices and performing data communication with the one or more network devices. In such embodiments, as described below, the network interface 117 is configured to receive from the network devices, for example, usage information or data of the users of the computer network, cost-related and/or worth-related information of the users of the computer network (e.g., from the database 120), etc. The network interface 117 is also configured to transmit to the network nodes 130, for example, control instructions, commands, policy update information, etc. In some embodiments, operations of the network interface 117 are controlled by instructions or code stored in the memory 119 (e.g., within a network communications module that is not shown in FIG. 1).

The network resources 150 represent one or more network resources associated with the computer network. In some embodiments, the network recourses 150 can include any suitable type of network resource such as, for example, network bandwidth, allocated time of usage, priority of access, access to a certain type of network or service (e.g., an access to a 4G network in lieu of a 3G network, an access to a 3G network in lieu of a 2G network), and/or the like. As used herein, the term “bandwidth” generally connotes the information-carrying capacity of a network, but can also refer to the amount of network capacity allocated to a particular user (e.g., in megabits or gigabits per second). The term “network” or “computer network” refers generally to a network of computers, routers, switches or other nodes, including, without limitation, the Internet and the public telecommunications infrastructure.

In some embodiments, the network resources 150 can be shared by a group of multiple users or customers of the computer network. In other words, the network resources 150 are at least partially allocated to the group of users. In some embodiments, each user or customer of the computer network can be an entity (e.g., a person, a company, an organization, etc.) that is permitted to use the network resources 150 of the computer network. For example, a user can be a person who pays a subscribing fee to use an access with a certain bandwidth to the Internet. For another example, a user can be a company that pays a monthly fee for access to a 4G network. For yet another example, a user can be an organization that is allowed to use the computer network within a certain time period (e.g., 8 AM to 6 PM on weekdays).

The network node(s) 130 can be any device(s) deployed in the computer network that can control access of a user to the network resources 150. In some embodiments, such a network node 130 can be, for example, a router, a hub, a switch, a networking server, a gateway, abridge, a firewall, an interface controller, a wireless access point (WAP), or any other type of networking device. In some embodiments, a network node can also be referred to as a network element, a network device, etc.

In some embodiments, the system 100 is configured to perform policy control to enable subscriber-specific policies that improve or maximize performance and/or financial objectives of network operators of the computer network. In one embodiment, allocation of network resources 150 for each user (or customer) is adjusted based on the “cost” of a given user (or customer) to the computer network (or network proprietor) versus the “worth” of the user (or customer) to the computer network or proprietor. Specifically, the cost may be the current or future predicted network resource (e.g., bandwidth) directly consumed by the user (or customer). The cost may additionally include other factors, such as bandwidth indirectly consumed by the user (or customer). For example, the user may trigger other users to consume additional bandwidth via, e.g., social media. For another example, the cost factors may include the propensity of the user to file a complaint. The worth of the user (or customer), on the other hand, includes payment information of the user such as, for example, subscription fees paid by the user, as well as other factors such as payment history or overage charge history and payment of the user.

In some embodiments, allocation of the network resources 150 is based at least in part on customer cost and worth. Such an allocation may occur in real time. Specifically, for example, resource utilization and usage may be probed or otherwise measured at set intervals in time, such as every 10 ms, 100 ms, 1 second, 10 seconds, 1 minute, or any other suitable time interval. Subsequently, corresponding changes in network policies may be made after and in response to each measurement. In some embodiments, more measurements and policy adjustments are made during peak-usage times when network-resource utilization is highest and, at non-peak times, fewer policy adjustments are made.

In some embodiments, the control policy of the computer network can be changed in any suitable fashion. For example, a centralized self-organizing network (“SON”) or similar controller can be used to control a type of cellular phone service to network customers. In this case, a higher-value customer, for example, may be assigned a high-speed (e.g., 4G) network service while a lower-value customer may be assigned a lower-speed (e.g., 3G) network service; that is, the higher-value customer is assigned more bandwidth than the lower-value customer.

A cost and/or worth associated with a user of the computer network can be computed in any suitable method, reflecting the priorities and/or constraints of the network and its proprietors. For example, the worth of a user can be the dollar value of the fees paid by that user; the fees may be part of a monthly subscription, an averaged value from a history of fees paid for no-subscription service, or a combination of the two. In some instances, the fees paid by the user may be assigned a number, tier, bracket, or other ranking or category instead of using the dollar value.

In some embodiments, the worth of a user may include or be influenced by one or more factors (known as worth factors). For example, a user that has recently upgraded service may be assigned a higher worth than one that has recently downgraded service. A user that consistently accrues overage fees (by, for example, consuming more than a maximum allowed bandwidth in a given time period) but also consistently pays these fees may be assigned a higher worth than a customer that never accrues overage fees and/or is tardy in paying said overage fees. The quantitative measure of worth factors may be in dollars or may be reflected as a weighting factor applied to the user worth value, and the magnitude of a worth factor may be set based on the economic priorities of the network proprietor.

In some embodiments, the cost of a user includes, for example, the bandwidth consumed by the user. Similar to the worth of a user, the cost of a user may simply be the number value of the consumed bandwidth. The bandwidth may be the instant bandwidth consumed, average bandwidth consumed over a period of time, or predicted future bandwidth. The prediction of future bandwidth usage for a subscriber may be based on historical bandwidth usage of the subscriber, historical usage of other subscribers, or predicted or known future events (such as, for example, scheduled network maintenance, or the scheduled release of a popular on-demand television show or movie).

Like the worth, however, the cost may be influenced by one or more factors (known as cost factors). For example, a higher-cost customer may be one that continually and consistently logs support calls or files customer complaints. For another example, higher-cost subscribers may be the ones that facilitate or spark others to consume bandwidth by, for example, posting popular links on social-media sites. Once again, the quantitative measure of cost factors may be in dollars or may be reflected as a weighting factor applied to the user cost value, and the magnitude of a cost factor may be set based on the economic priorities of the network proprietor as well as overall network capacity.

In some embodiments, the database 120 is configured to store records of data and/or information for users of the computer network. In some embodiments, as shown in FIG. 1, the database 120 or portion thereof can be hosted at a remote device that is physically separate from the server device 110. In such embodiments, the server device 110 (e.g., the user analysis module 111) is configured to access (e.g., via the computer network) the database 120 and retrieve data from the database 120. Additionally, the server device 110 can be configured to write to the database 120 such that the server device 110 can update data stored in the database 120 (e.g., controlled by a network operator). In some other embodiments, although not shown in FIG. 1, the database 120 or portions thereof can be hosted on the server device 110. For example, the database 120 can be stored within the memory 119. In such embodiments, the server device 110 (e.g., the user analysis module 111) can retrieve data from the database 120 by, for example, accessing and reading from the memory 119.

Data records can be stored in the database 120 in any suitable form (e.g., as a table, a list, etc.). In some embodiments, records stored in the database 120 include worth factors, worth weights, cost factors and cost weights of each user. Table 1 illustrates worth-related records of user A, which include a weight and value of user A for each worth factor. Table 2 illustrates cost-related records of user A, which include a weight and value of user A for each cost factor.

TABLE 1
Worth Factors and Worth Weights of a User
User A—Worth

| Factor | Weight | Value |
|---|---|---|
| Fees paid by user | WW1 (positive) | WV1 |
| Recent upgrade | WW2 (positive) | WV2 |
| Recent downgrade | WW3 (negative) | WV3 |
| Accrues but pays overage fees | WW4 (positive) | WV4 |
| Payment promptness | WW5 (positive) | WV5 |

As shown in Table 1, each user (e.g., user A) has a weight and value for each of five exemplary worth factors: “fees paid by user,” “recent upgrade,” “recent downgrade,” “accrues but pays overage fees,” and “payment promptness.” In some embodiments, the worth factors also include, for example, a payment history, overage charge history, overage charge payment promptness, or any other suitable factors that represent the monetary contribution of a user to the computer network.

If the weight for a worth factor (e.g., WW1 for “fees paid by user”) is a positive value, it indicates that the worth factor represents a positive contribution to the overall worth of the user. That is, the higher the weight and/or value for that worth factor, the more worth the user brings to the computer network. In contrast, if the weight for a worth factor (e.g., WW3 for “recent downgrade”) is a negative value, it indicates that the worth factor represents a negative contribution to the overall worth of the user. That is, the higher the weight and/or value for that worth factor, the less worth the user brings to the computer network. Additionally, the value of a worth factor is typically a positive value.

Overall, the total worth of a user (e.g., user A) to the computer network can be calculated by, for example, multiplying the weight of each worth factor by the value of that worth factor, then summing the products. Thus, according to Table 1, the total worth of user A can be calculated as Worth=WW1×WV1+WW2×WV2+WW3×WV3+WW4×WV4+WW5×WV5, where WW3×WV3 produces a negative value (because WW3 is negative) and all other products are positive values.

TABLE 2
Cost Factors and Cost Weights of a User
User A—Cost

| Factor | Weight | Value |
|---|---|---|
| Bandwidth consumed | CW1 (positive) | CV1 |
| Bandwidth consumed < | CW2 (negative) | CV2 |
| bandwidth paid for | | |
| Logged support calls within | CW3 (positive) | CV3 |
| last month | | |
| Propagation to other users | CW4 (positive) | CV4 |

Similarly, as shown in Table 2, each user (e.g., user A) has a weight and value for each of four cost factors: “bandwidth consumed,” “bandwidth consumed<bandwidth paid for,” “logged support calls within last month,” and “propagation to other users.” In some embodiments, the cost factors can also include, for example, a compliant-filing history, peak-time usage history, file-sharing history, or any other suitable factors that represent the usage of the network resources of the computer network by a user.

If the weight for a cost factor (e.g., CW1 for “bandwidth consumed”) is a positive value, it indicates that the cost factor represents a positive contribution to the overall cost of the user. That is, the higher the weight and/or value for that cost factor, the more cost the user imposes on the computer network. In contrast, if the weight for a cost factor (e.g., CW2 for “bandwidth consumed<bandwidth paid for”) is a negative value, it indicates that the cost factor represents a negative contribution to the overall cost of the user. That is, the higher the weight and/or value for that cost factor, the less cost the user imposes on the computer network. Additionally, the value of a cost factor is typically a positive value.

Overall, the total cost of a user (e.g., user A) to the computer network can be calculated by, for example, multiplying the weight of each cost factor by the value of that cost factor, then summing the products. Thus, according to Table 2, the total cost of user A can be calculated as Cost=CW1×CV1+CW2×CV2+CW3×CV3+CW4×CV4, wherein CW2×CV2 produces a negative value (because CW2 is negative) and all other products are positive values.

Once a cost and a worth have been computed for a customer, a worth-to-cost ratio may be computed. In some embodiments, the ratio is simply dollars to megabytes/megabits. In other embodiments, as illustrated in Tables 1 and 2 above, factors other than a simple ratio of dollars received over bandwidth consumed may be used to compute the worth-to-cost ratio. These other factors (e.g., cost factors, worth factors) can be incorporated into the calculation of worth-to-cost ratio by, for example, assigning weighting factors thereto and modifying the cost and/or worth by multiplying them by the corresponding weighting factors. Thus, as a result, the worth-to-cost ratio for user A can be calculated based on data stored in Tables 1 and 2 as Worth/Cost. In some embodiments, the values of the weighting factors may be determined heuristically by, for example, comparing a change in a weighted factor (e.g., a weighted cost factor or a weighted worth factor) against a network policy and then determining if net revenue is changed positively or negatively in response to the change in the weighting factor.

In some embodiments, the worth-to-cost ratio may be further computed for a group of customers connected to a local network resource or other network bottleneck. For example, the worth-to-cost ratios of each customer connected to a cellular tower may be compared and resources in the cellular tower assigned accordingly. Other network bottlenecks may include, for example, servers hosting popular media files, network links providing services to remote or isolated customers, or any other such network feature or bottleneck.

In some embodiments, the network resources 150 may be quantized or binned into separate classes such as, for example, one bin for a 4G network and one for a 3G network, one bin for 5-10 Mbps service and one for 10-20 Mbps service, and/or the like. The customers may be divided into corresponding groups based on their worth-to-cost ratios and assigned to different classes accordingly. In other embodiments, the network resources 150 are not binned, and customers are assigned with unique or semi-unique allotments of the resource. For example, one customer might be assigned 16 Mbps bandwidth, while another customer is assigned 9 Mbps bandwidth.

In some embodiments, more than one customer may have the same worth-to-cost ratio. For example, when a cellular-phone company offers package deals for set cost and bandwidth and multiple customers subscribe to such a package deal, each of the customers pays the same (or substantially similar) fees and receives the same (or substantially similar) network resources (e.g., bandwidth), thus generating the same worth-to-cost ratio across customers.

In some embodiments, customers can be organized into different worth-to-cost groups based on their worth-to-cost ratios, where customers in the same worth-to-cost group have the same or similar worth-to-cost ratios, and customers from different worth-to-cost groups have different worth-to-cost ratios. In such embodiments, customers can be ordered based on their associated worth-to-cost groups. The order can be associated with, for example, a queue, ranking, priority list, or any other ordering (e.g., an ordering of customers for connection to a recently rebooted cellular-phone tower). Specifically, for example, customers from a worth-to-cost group having a (relatively) higher worth-to-cost ratio are assigned a higher order (e.g., higher priority in a queue) than customers from another worth-to-cost group having a (relatively) lower worth-to-cost ratio. In such embodiments, the order of customers within the same worth-to-cost group may be assigned randomly or rotated periodically.

In some embodiments, certain types of network traffic may take precedence over other types regardless of the respective worth-to-cost ratios. For example, the audio traffic of a low-ratio customer may take precedence over the video traffic of a high-ratio customer. For another example, the data traffic of a low-ratio customer may take precedence over the media traffic (e.g., audio or video) of a high-ratio customer.

Any suitable type of network data may be analyzed to determine the real-time cost of a customer, and the present application is not limited to any particular probe or metric. Such network data may include, for example, radio-access network key performance indicators, subscriber rate plans, real-time flow data, call detail records, and/or the like. Data sources may include, for example, concurrent flows, content type, origin, duration, video identification and metadata, subscriber profile, subscriber device type, network operational costs, device capabilities matrix, and/or the like.

Any number or type of policy changes may be used to differentiate high-value customers and maximize their experience and revenue derived from them. Such policy changes may include, for example, video optimization of subscriber flows, rate clamping of subscriber flows, rate shaping of subscriber flows, stopping flows at a load balancer, firewall, router, steering flows to a specific location upon detection of a policy exception (e.g., security, BW, usage exceptions, etc.), rebalancing of flows to neighboring cells, grooming of subscribers from 4G to 3G, and/or the like.

In some embodiments, the key performance indicators are analyzed before and after the broadcasting of a policy change and the effect thereon may be measured. Policy changes that produce no, little, or negative changes in the key performance indicators may be reversed or otherwise rolled back; while other effective policy changes may be thereafter enacted. In some embodiments, if the policy changes are broadcast in response to an event (e.g., network congestion), the policy changes can be rolled back if and when the event ceases to occur (e.g., the network is no longer congested).

Returning to FIG. 1, the server device 110 includes the user analysis module 111 and the network control module 113 (although, in some embodiments, the network control module 113 is a separate, dedicated hardware component). In some embodiments, a server device can include more or fewer modules than those shown in FIG. 1. Each module included in the server device 110 can be a hardware-based module (e.g., a DSP, a FPGA, an ASIC, etc.), a software-based module (e.g., a module of computer code executed at a processor, a set of processor-readable instructions executed at a processor, etc.), or a combination of hardware and software modules. Instructions or code of each module can be stored in the memory 119 of the server device 110 and executed at the processor 115 (e.g., a CPU) of the server device 110. Overall, the user analysis module 111 and the network control module 113 can be configured to collectively perform the method for allocating the network resources 150 among the users of the computer network, as described above.

Specifically, the user analysis module 111 is configured to, among other functions, access and retrieve data from the database 120—in particular, cost-related data and worth-related data of users of the computer network including, for example, weights and values of each cost factor and each worth factor for each user (as shown and described above with respect to Tables 1 and 2).

In some embodiments, as shown in FIG. 1, the user analysis module 111 can also receive or retrieve usage information 160 related to the network resources 150 of the users from the computer network (e.g., from network devices of the computer network). In such embodiments, the user analysis module 111 can retrieve the usage information and/or data partially from the database 120 and partially from other network devices of the computer network. For example, the user analysis module 111 can retrieve cost weights, worth weights and worth values of the users from the database 120, since these are predefined values and not affected by actual usage of the users. Meanwhile, the user analysis module 111 can retrieve actual usage information 160 of the users from other network devices (e.g., routers, switches, etc.) of the computer network, enabling the user analysis module 111 to calculate the cost values of the users based on the actual usage information 160 of the users.

Upon receiving the necessary data (e.g., cost values, cost weights, worth values, worth weights, etc.) from the database 120 and/or other network devices of the computer network, the user analysis module 111 computes, for each user, an overall cost and an overall worth of that user. As described above with respect to Tables 1 and 2, an overall cost for a user can be calculated based at least on the cost factors (e.g., cost values) and cost weights associated with that user. For example, the overall cost for user A in Table 2 can be calculated as Cost=CW1×CV1+CW2×CV2+CW3×CV3+CW4×CV4. Similarly, an overall worth for a user can be calculated based at least on the worth factors (e.g., worth values) and worth weights associated with that user. For example, the overall worth for user A in Table 1 can be calculated as Worth=WW1×WV1+WW2×WV2+WW3×WV3+WW4×WV4+WW5×WV5.

Subsequently, the user analysis module 111 computes, for each user, a worth-to-cost ratio based on the overall cost and overall worth of that user. For example, the worth-to-cost ratio for user A in Tables 1 and 2 can be calculated as Worth/Cost. Thus, the user analysis module 111 is configured to identify a group of high-value users and a group of low-value users based on their calculated worth-to-cost ratios. As a result, each user from the group of high-value users has a worth-to-cost ratio higher than the worth-to-cost ratio of each user from the group of low-value users. In some embodiments, the user analysis module 111 divides the users into more than two groups or any number of groups based their worth-to-cost ratios. Accordingly, users from different groups have different worth-to-cost ratios, and are thus subject to different control policies.

Next, the user analysis module 111 sends, to the network control module 113, a signal containing information of the high-value users from the group of high-value users, and/or information of the low-value users from the group of low-value users. Thus, the network control module 113 is able to determine whether a user is identified as a high-value user or a low-value user, and further determine which control policy applies to that user.

In response to receiving the signal from the user analysis module 111 and determining a control policy for each user, the network control module 113 is configured to, among other functions, provide preferential access to the network resources 150 to the group of high-value users relative to the access (i.e., a non-preferential or ordinary access) provided to the group of low-value users. Such preferential access to the network resources 150 can include, for example, a higher bandwidth, a longer time period of access, access to a faster network (e.g., an access to a 4G network in lieu of a 3G network, or an access to a 3G network in lieu of a 2G network), and various combinations of the above and other options. As a result, a user with a (relatively) higher worth-to-cost ratio is typically accorded better access to and higher priority of using the network resources 150 than a user with a (relatively) lower worth-to-cost ratio. In some embodiments, preferential access to the network resources 150 can be associated with, for example, network bandwidth, network throughput, network-connection order, or any other suitable representation of usage associated with the network resources 150.

In operation, as shown in FIG. 1, the network control module 113 is configured to send policy updates 170 to the network nodes 130. Such policy updates can include information pertaining to the control policies that are assigned to each user based on their newly-calculated worth-to-cost ratios. In some embodiments, the policy updates 170 include updates of the new control policies with respect to the existing control policies. For example, the policy updates 170 can include reducing the bandwidth assigned to a low-value user from 100 Mbps to 50 Mbps. Other examples include increasing the permitted access time assigned to a high-value user from 8 hours per day to 12 hours per day; reducing the allowable maximum download size for a low-value user from 1 GB per day to 500 MB per day; and/or upgrading the network for a high-value user from a 3G network to a 4G network. In some embodiments, the policy updates 170 include, for example, a policy-update command, instruction, signal, or the like.

In response to receiving the policy updates 170 from the network control module 113, the network nodes 130 can implement the policy updates 170 in the computer network by, for example, enforcing policy control 140 for the network resources 150 at each network node 130, such that the policy control 140 is in compliance with the policy updates 170.

Additionally, in some embodiments, the server device 110 is configured to detect, in real time and prior to sending the policy updates 170 to the network nodes 130, an over-allocation condition of the network resources 150. For example, the user analysis module 111 or the network control module 113 can determine the existence of such an over-allocation condition of the network resources 150 based on the usage information 160 received from the network devices of the computer network. In such embodiments, the server device 110 can be configured to provide preferential access to the network resources 150 only to high-priority users of the computer network. For example, the server device 110 can provide a first preferential access only to users included in the high-value group, but not to users included in the low-value group. Furthermore, when the over-allocation condition eases or ceases, the server device 110 can be configured to provide a second preferential access to the network resources 150 to the group of low-value users. In some instances, the first preferential access provided to high-value users can be the same as the second preferential access provided to the low-value users. In other instances, the two preferential accesses can be different. For example, the first preferential access may permit a relatively higher access to or utilization of the network resources than that of the second preferential access.

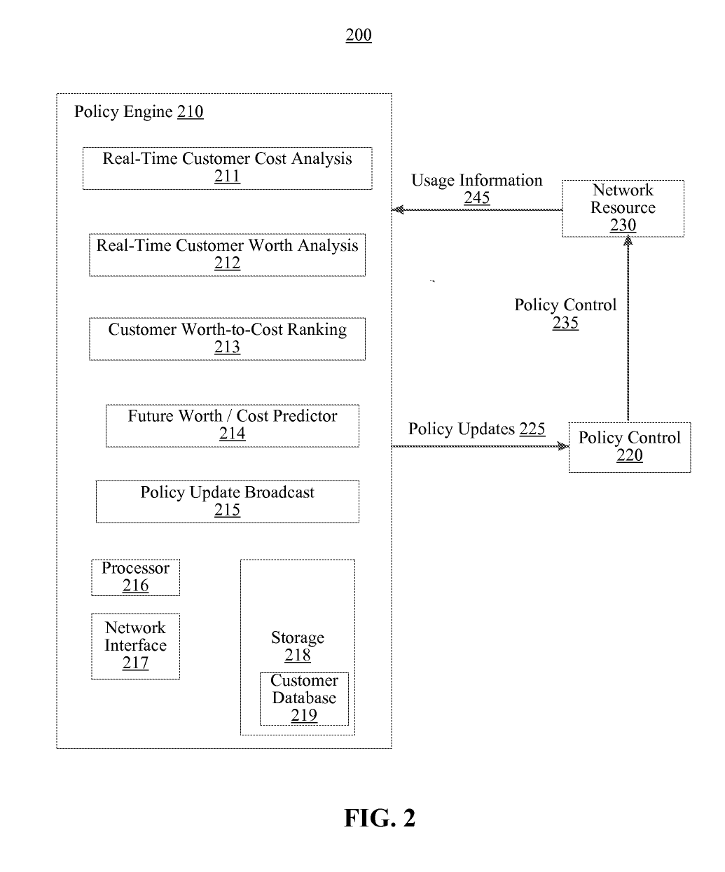

FIG. 2 is a schematic illustration of another system 200 for allocating network resources in a computer network in accordance with some embodiments. As shown in FIG. 2, the system 200 includes a policy engine 210, a policy control 220 that is functionally similar to the network nodes 130, and a network resource 230 that is similar to the network resources 150 in FIG. 1. The policy engine 210 is structurally and functionally similar to the server device 110 shown and described above with respect to FIG. 1. Specifically, the policy engine 210 includes a processor 216 that is structurally and functionally similar to the processor 115 in FIG. 1; a network interface 217 that is structurally and functionally similar to the network interface 117 in FIG. 1; a storage 218 that is structurally and functionally similar to the memory 119 in FIG. 1; and modules including a real-time customer cost analysis module 211, a real-time customer worth analysis module 212, a customer worth-to-cost ranking module 213, a future worth/cost predictor 214, and a policy update broadcast module 215.

In some embodiments, each module included in the policy engine 210 can be a hardware-based module (e.g., a DSP, a FPGA, an ASIC, etc.), a software-based module (e.g., a module of computer code executed at a processor, a set of processor-readable instructions executed at a processor, etc.), or a combination of hardware and software modules. Instructions or code of each module can be stored in the storage 218 of the policy engine 210 and executed at the processor 216 (e.g., a CPU) of the policy engine 210. Overall, the real-time customer cost analysis module 211, the real-time customer worth analysis module 212, the customer worth-to-cost ranking module 213, and the future worth/cost predictor 214 can be configured to collectively analyze and determine control policies related to the network resource 230 for the customers, which is similar to the function of the user analysis module 111 shown and described above with respect to FIG. 1. Furthermore, the policy update broadcast module 215 can be configured to implement control policies related to the network resource 230 for the customers, which is similar to the network control module 113 shown and described above with respect to FIG. 1.

As shown in FIG. 2, the storage 218 includes a customer database 219, which is structurally and functionally similar to the database 120 in FIG. 1. That is, the customer database 219 is configured to store cost-related and worth-related data and/or information of the customers. Similar to the database 120 in FIG. 1, the customer database 219 can be hosted at the policy engine 210 (as shown in FIG. 2), or hosted at a remote location and accessible to the policy engine 210 (not shown in FIG. 2).

In operation, the policy engine 210 receives user information 245 (similar to user information 160 in FIG. 1) related to the network resource 230 from the computer network. The received user information 245 typically includes real-time cost (e.g., usage) information of each customer. The policy engine 210 can then optionally store the usage information 245 in the customer database 219 (e.g., at corresponding cost-related records of each customer).

The real-time customer cost analysis module 211 retrieves cost-related customer information from the customer database 219 and/or the usage information 245. For example, the real-time customer cost analysis module 211 can retrieve predefined cost weights from the customer database 219, and determine real-time cost values based on the real-time usage information 245. The real-time customer cost analysis module 211 can then calculate a real-time cost for each customer.

The real-time customer worth analysis module 212 retrieves worth-related customer information from the customer database 219. For example, the real-time customer worth analysis module 212 can retrieve predefined worth weights and worth values from the customer database 219. The real-time customer worth analysis module 212 can then calculate a (real-time) worth for each customer.

The customer worth-to-cost ranking module 213 calculates a worth-to-cost ratio based on the cost of each customer determined by the real-time customer cost analysis module 211 and the worth of each customer determined by the real-time customer worth analysis module 212. The customer worth-to-cost ranking module 213 can then order the customers based on their worth-to-cost ratios and place them into different groups (e.g., a high-value group and a low-value group).

The future worth/cost predictor 214 is configured to define or update, based on the grouping performed by the customer worth-to-cost ranking module 213, a control policy related to the network resource 230 for each customer that is to be implemented in the computer network. For example, the future worth/cost predictor 214 can define a control policy with a more-than-average allocation of the network resource 230 for a high-value customer, and define another control policy with a less-than-average allocation of the network resource 230 for a low-value customer.

The policy update broadcast module 215 is configured to implement the control policies defined at the future worth/cost predictor 214. Specifically, as shown in FIG. 2, the policy update broadcast module 215 can broadcast the policy updates 225 to the policy control 220, which can include one or more networking devices (e.g., routers, gateways, switches, servers, etc.) of the computer network.

In response to receiving the policy updates 225 from the policy update broadcast module 215, the policy control 220 can implement the policy updates 225 in the computer network by, for example, enforcing policy control 235 for the network resource 230 at each associated network device, wherein the policy control 235 is in compliance with the policy updates 225.

The foregoing description, for purpose of explanation, has been described with reference to specific embodiments. However, the illustrative discussions above are not intended to be exhaustive or to limit the present application to the precise forms disclosed. Many modifications and variations are possible in view of the above teachings. The embodiments were chosen and described in order to best explain the principles of the present application and its practical applications, to thereby enable others skilled in the art to best utilize the present application and various embodiments with various modifications as are suited to the particular use contemplated.

It should also be noted that embodiments of the present invention may be provided as one or more computer-readable programs embodied on or in one or more articles of manufacture. The article of manufacture may be any suitable hardware apparatus, such as, for example, a floppy disk, a hard disk, a CD ROM, a CD-RW, a CD-R, a DVD ROM, a DVD-RW, a DVD-R, a flash memory card, a PROM, a RAM, a ROM, or a magnetic tape. In general, the computer-readable programs may be implemented in any programming language. Some examples of languages that may be used include C, C++, or JAVA. The software programs may be further translated into machine language or virtual machine instructions and stored in a program file in that form. The program file may then be stored on or in one or more of the articles of manufacture.

While particular embodiments are described above, it will be understood it is not intended to limit the present application to these particular embodiments. On the contrary, the present application includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the present application herein is for the purpose of describing particular embodiments only and is not intended to be limiting of the present application. As used in the description of the present application and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

What is claimed is:

1. A method for allocating computer-network resources, the method comprising the steps of:
calculating, for each network user from a plurality of network users, a worth of that network user based at least on a usage fee paid by that network user;
calculating, for each network user from the plurality of network users, a cost of that network user based at least on a network bandwidth consumed by that network user;
calculating, for each network user from the plurality of network users, a worth-to-cost ratio based on the worth and cost of that network user;
identifying a group of high-value network users and a group of low-value network users from the plurality of network users, each network user from the group of high-value network users having a worth-to-cost ratio higher than a worth-to-cost ratio of each network user from the group of low-value network users; and
providing a preferential access to at least one network resource to the group of high-value network users relative to an access provided to the group of low-value network users.

2. The method of claim 1, wherein calculating a worth of a network user comprises calculating the worth of the network user based on at least one of a payment history, payment promptness, overage charge history, or overage charge payment promptness of that network user.

3. The method of claim 1, wherein calculating a cost of a network user comprises calculating the cost of the network user based on at least one of a complaint-filing history, peak-time usage history, or file-sharing history of that network user.

4. The method of claim 1, wherein the preferential access is associated with at least one of a network bandwidth, network throughput, or network-connection order associated with the network resource.

5. The method of claim 1, wherein the preferential access comprises an access to a 4G network in lieu of a 3G network or an access to a 3G network in lieu of a 2G network.

6. The method of claim 1, wherein providing the preferential access comprises transmitting a policy-update command to a network node or element associated with the network resource.

7. The method of claim 1, further comprising detecting, in real time and prior to providing the preferential access, an over-allocation condition of the network resource.

8. The method of claim 7, further comprising providing a preferential access to the network resource to the group of low-value network users when the over-allocation condition ceases.

9. A system for allocating network resources in a computer network, the system comprising:
nonvolatile computer storage including a database for storing user information of a plurality of network users, the database including records that specify, for each network user from the plurality of network users, (i) a plurality of worth factors and worth weights associated with each of the worth factors, and (ii) a plurality of cost factors and cost weights associated with each of the cost factors;
a network controller for allocating network resources among the plurality of network users;
one or more computer processors configured for executing computer instructions; and
a user analysis module that is executable by the one or more computer processors, the user analysis module being configured to:
i. compute, for each network user from the plurality of network users, a cost based at least on the cost factors and cost weights associated with that network user;
ii. compute, for each network user from the plurality of network users, a worth based at least on the worth factors and worth weights associated with that network user;
iii. compute, for each network user from the plurality of network users, a worth-to-cost ratio based on the worth and cost of that network user;
iv. identify a group of high-value network users and a group of low-value network users from the plurality of network users, each network user from the group of high-value network users having a worth-to-cost ratio higher than a worth-to-cost ratio of each network user from the group of low-value network users; and
v. cause the network controller to provide a preferential access to at least one network resource to the group of high-value network users relative to an access provided to the group of low-value network users.

10. The system of claim 9, wherein the worth factors for a network user include usage fees paid by that network user.

11. The system of claim 9, wherein the cost factors for a network user include a network bandwidth consumed by that network user.

12. The system of claim 9, wherein the at least one network resource includes a network bandwidth associated with the computer network.

13. The system of claim 9, wherein the preferential access comprises an access to a 4G network in lieu of a 3G network or an access to a 3G network in lieu of a 2G network.

14. The system of claim 9, wherein the network controller is configured to provide the preferential access to the at least one network resource by transmitting a policy-update command associated with the at least one network resource to a network node or element in the computer network.

15. A server device for allocating network resources in a computer network among a plurality of network users, the server device comprising a user analysis module and a network controller module, wherein:
the user analysis module is configured to:
i. retrieve, from a database storing user-specific data for the plurality of network users, payment data and usage data of each network user from the plurality of network users;
ii. compute, for each network user from the plurality of network users, a worth based on the payment data of that network user;
iii. compute, for each network user from the plurality of network users, a worth based on the usage data of that network user;
iv. compute, for each network user from the plurality of network users, a worth-to-cost ratio based on the worth and cost of that network user;
v. identify a group of high-value network users and a group of low-value network users from the plurality of network users, each network user from the group of high-value network users having a worth-to-cost ratio higher than a worth-to-cost ratio of each network user from the group of low-value network users; and
vi. send, to the network controller module, a signal containing information of the high-value network users; and
the network controller module is configured to provide, in response to receiving the signal from the user analysis module, a preferential access to at least one network resource to the group of high-value network users relative to an access provided to the group of low-value network users.

16. The server device of claim 15, wherein the payment data of a network user includes usage fees paid by that network user.

17. The server device of claim 15, wherein the usage data of a network user includes a network bandwidth consumed by that network user.

18. The server device of claim 15, wherein the at least one network resource includes a network bandwidth associated with the computer network.

19. The server device of claim 15, wherein the user analysis module is configured to detect, in real time and prior to sending the signal, an over-allocation condition of the at least one network resource based on the usage data of the plurality of network users.

20. The server device of claim 19, wherein the network controller module is configured to provide a preferential access to the at least one network resource to the group of low-value network users when the over-allocation condition ceases.
